(19) United States
(12) Patent Application Publication
(10) Pub. No.: US 2024/0279111 A1
(43) Pub. Date: Aug. 22, 2024

(54) Use of Limestone Rock Aggregate (LRA) as a Component for the Production of Portland Cement Clinker, Portland Cement, or Related Mineralogy

(71) Applicant: Tyche Extraction Company, LLC, Lakeway, TX (US)

(72) Inventors: Billy Shane McDade, Lakeway, TX (US); Blake Tucker Branson, Missouri City, TX (US)

(21) Appl. No.: 18/431,106

(22) Filed: Feb. 2, 2024

Related U.S. Application Data
(60) Provisional application No. 63/485,357, filed on Feb. 16, 2023.

(51) Int. Cl. C04B 7/40; C04B 7/04; C04B 7/44; C04B 14/02; C04B 28/04

(52) U.S. Cl. CPC C04B 7/40; C04B 7/04; C04B 7/44; C04B 14/026; C04B 28/04

(57) ABSTRACT

Embodiments relate to use of Limestone Rock Aggregate (“LRA”) as a component used to manufacture clinker, wherein the clinker is used in the manufacture of Portland cement. LRA is a naturally occurring limestone deposit that has been impregnated with various bituminous and hydrocarbon components, including asphaltenes and lighter hydrocarbons. Because of the presence of hydrocarbon components, LRA is “energy positive” making it easier (e.g., requiring less energy) to kiln heat than pure, or common, limestone. As will be explained herein, the LRA can be treated before being used as a component cement manufacture. The treatment of the LRA can involve removal, or extraction, of certain bituminous material (e.g., light hydrocarbons from the LRA). This extracted bituminous material can be used in other material processes (e.g., crude oil refining). The treatment of LRA can also involve manipulating the gradation of crushed LRA material to improve its minerology for cement production.

### CROSS-REFERENCE TO RELATED APPLICATIONS

This patent application is related to and claims the benefit of priority of U.S. provisional patent application No. 63/485,357, filed on Feb. 16, 2023, the entire contents of which is incorporated herein by reference.

### FIELD

Embodiments relate to use of Limestone Rock Aggregate (“LRA”) limestone as a component of clinker, wherein the clinker is a component of Portland cement.

### BACKGROUND

Conventional means to make Portland cement involves use of limestone (e.g., pure or common limestone). Generally, limestone is crushed and combined with other material and fluxes (e.g., alite, belite, tricalcium aluminate, tetracalcium alumino ferrite, etc.) to generate a clinker precursor material (or “clinker precursor”), which is heated to generate a clinker material (or “clinker”). Generally, for optimal properties and material processing, the limestone is crushed to a size that is three inches or less in diameter to form the clinker precursor. The heat treatment applied to the clinker precursor to generate clinker is referred to as kiln treating, which is done to degrade the limestone rock (e.g., cause calcium carbonate to react with silica to form calcium silicates). The clinker is then ground into a fine powder, and is mixed with limestone and gypsum (and potentially other materials) to generate a mixture of Portland cement. The resultant mixture can be ground again to ensure uniformity of particle size.

Because Portland cement is a preferred construction material, it is widely used throughout the world. Manufacturing of Portland cement is known to be energy intensive, and it contributes significantly to greenhouse gas emissions.

Use of LRA limestone instead of pure or common limestone can significantly reduce the amount of energy required to make Portland cement.

### SUMMARY

Embodiments relate to use of LRA limestone as a component of clinker, wherein the clinker is used to manufacture Portland cement. LRA limestone is a naturally occurring limestone deposit that has been impregnated with various bituminous, or hydrocarbon components, including asphaltenes and lighter hydrocarbons. Because of the presence of the bituminous components, LRA limestone is “energy positive” making it easier (e.g., requiring less energy) to heat to the point of degradation than pure or common forms of limestone. As will be explained herein, the LRA limestone can be treated before being used as a component of clinker. This pre-treatment of the LRA limestone can involve removal, or extraction, of certain bituminous material (e.g., light hydrocarbons and sulfur from the LRA limestone). This extracted bituminous material can be used in other material processes (e.g., those used in the refining of crude oil).

Embodiments disclosed herein refer to use of LRA limestone as a component for the manufacture of Portland cement and clinker for the same. However, it is understood that Portland cement is exemplary, and that the innovative techniques discussed herein can be similarly applied to mineralogical equivalents of Portland cement and Portland cement clinker.

As will be explained herein, the gradation with which LRA limestone is crushed, grinded, screened, etc. can also be modified to make it more desirable as a component of clinker. For instance, the material composition of LRA limestone, the desired material properties of the clinker or Portland cement, whether and to what extend the LRA limestone is pre-treated, etc. can be factors in determining the gradation with which LRA limestone is processed. Gradation of LRA limestone, as used herein, refers to processing (crushing, grinding, screening, and/or washing) of LRA limestone to provide a desired prevalence of various particle sizes of a volume of LRA limestone or limestone material containing LRA limestone.

Whether pre-treated or not, LRA limestone can provide significant advantages as a component of clinker, as compared to pure or common limestone. LRA limestone is a commonly used road construction aggregate, the production of which produces a crusher fines bi-product (“LRA limestone crusher fines”). Use of LRA limestone crusher fines as the LRA limestone component in the formation of clinker precursor can provide additional benefits because LRA limestone crusher fines are already finely crushed, eliminating the need for crushing the limestone before clinker production. In addition, the natural process that impregnated LRA limestone with bituminous material also “degraded”, or caused small fractures in the LRA limestone. This degraded nature of the limestone rock of the LRA limestone further reduces the energy required to kiln treat the LRA limestone of the clinker precursor to form clinker, as compared to pure or common limestone rock.

In addition, it is believed that LRA limestone contains carbon nanostructures (e.g., graphene flakes). These carbon nanostructures, being part of the Portland cement mix, can provide for a stronger cement. Thus, the LRA limestone, being used as a component of clinker, can supply these carbon nanostructures. In addition, whether LRA limestone is used as a component of clinker or not, LRA limestone can be added to a Portland cement mix to supply these carbon nanostructures, once it has been treated with the hydrocarbon extraction process and finely ground.

Embodiments relate to the production of Portland cement. The Portland Cement, or the clinker produced as a step in its manufacture, can be produced using LRA limestone.

In some embodiments, the LRA limestone is natural LRA limestone and/or LRA limestone crusher fines produced as a by-product of earlier operations, specifically related to cement production or not.

In some embodiments, the LRA limestone is refined LRA limestone and/or LRA limestone crusher fines. The refined LRA limestone can be natural LRA limestone and/or LRA limestone crusher fines with at least some of the naturally occurring bituminous material, or hydrocarbon fractions, removed or extracted therefrom.

Embodiments can relate to a Portland cement mix. The Portland cement mix can be produced from a finely ground clinker material. The clinker material can include LRA limestone as a component of its manufacture.

In some embodiments, the LRA limestone is natural LRA limestone and/or LRA limestone crusher fines.

In some embodiments, the LRA limestone is refined LRA limestone. The refined LRA limestone and/or LRA limestone crusher fines can be natural LRA limestone with at least some of the naturally occurring bituminous material, or hydrocarbon fractions removed or extracted therefrom.

Embodiments can relate to a method of fabricating clinker material for use in Portland cement production. The method can involve using limestone and other additives to form clinker precursor material. The limestone of the clinker precursor material can include LRA limestone.

In some embodiments, the limestone of the clinker precursor material: can consist of LRA limestone; can consist essentially of LRA limestone; or can comprise LRA limestone.

In some embodiments, the limestone of the clinker precursor material can include a mixture of pure or common limestone and LRA limestone.

In some embodiments, the limestone of the clinker precursor material comprises: a) LRA natural limestone; or b) a mixture of pure or common limestone and LRA natural limestone, and the limestone of the clinker precursor material is crushed such that the limestone of the clinker precursor material has an average diameter of three inches or less. Alternatively, the limestone of the clinker precursor material consists of LRA limestone crusher fines, and no further crushing of the limestone of the clinker precursor material is necessary to fabricate the clinker.

In some embodiments, the method can involve treating the natural LRA limestone and/or the LRA limestone crusher fines to generate refined LRA limestone by removing or extracting at least some light fraction hydrocarbons.

In some embodiments, light fraction hydrocarbons can include hydrocarbon fractions having molecular weights from C1 to C14.

Embodiments can relate to a method of fabricating Portland cement. The method can involve kiln treating LRA limestone to produce a clinker material. The method can involve mixing the clinker material with limestone and gypsum.

In some embodiments, the kiln treating can burn hydrocarbon fractions contained by the LRA limestone.

In some embodiments, the clinker precursor comprises: a) natural LRA limestone; or b) a mixture of pure or common limestone and natural LRA limestone, and a) material or b) material, before being kiln treated to generate clinker, is crushed such that a) material or b) material has an average diameter of three inches or less. Alternatively, the clinker precursor consists of LRA limestone crusher fines, and no further crushing of the clinker precursor is necessary to fabricate the clinker.

In some embodiments, the kiln treatment can involve applying heat to the clinker precursor to raise the temperature of the clinker precursor within a range from 932° F. to 2,000° F.

In some embodiments, the kiln treatment can cause calcium carbonate to react with silica to form calcium silicates. The minimum temperature at which calcium carbonate reacts with silica to form calcium silicates can be 932° F.

In some embodiments, the method can involve treating the LRA limestone and/or LRA limestone crusher fines to generate refined LRA limestone by removing or extracting at least some light fraction hydrocarbons.

In some embodiments, light fraction hydrocarbons can include hydrocarbon fractions having molecular weights from C1 to C14.

Embodiments can relate to a method of improving strength of Portland cement. The method can involve adding LRA limestone as a component to clinker material for the Portland cement; and/or adding LRA limestone to a Portland cement mix. The LRA limestone can impart carbon nanostructures to the Portland cement.

In some embodiments, the carbon nanostructures can include graphene flakes or other carbon nanostructures.

In some embodiments, the LRA limestone material is processed to a more specific gradation before use in manufacturing Portland Cement or its clinker precursor. Achieving the desired gradation can be achieved through normal means of crushing, screening, and washing the LRA limestone, or other means of producing a desired gradation. Manipulating the gradation of LRA limestone particles is shown in the data to affect the percentage of LRA limestone that can be used as a component for the production of Portland Cement or clinker. The most desirable percentage of LRA limestone that is used as the total amount of the precursor feedstock to produce Portland cement may vary depending on the needs of the cement manufacturer. The ability to manipulate the percentage LRA limestone used as cement feedstock became evident from tests involving LRA limestone samples as a cement component was performed on various LRA limestone samples that had undergone the hydrocarbon extraction process. For example, in certain iterations, the hydrocarbon extraction process used only heat, which had a very limited effect on the amount of LRA limestone that could be used in the overall feedstock blend versus “raw” LRA limestone (i.e., LRA limestone that had not gone through the hydrocarbon extraction process). In other iterations, the LRA limestone was washed as part of the hydrocarbon extraction process. Washing an aggregate has the effect of separating finer particles from coarser particles. In these iterations, the more the LRA aggregate was washed, the higher the percentage of LRA as a percentage of the overall cement feedstock could be used.

An exemplary embodiment can relate to clinker precursor material. The clinker precursor material can include Limestone Rock Aggregate (“LRA”) limestone. The clinker precursor will be kiln treated to form clinker used in the production of Portland Cement or a mineralogical equivalent thereof.

In some embodiments, the LRA limestone is natural LRA limestone and/or LRA limestone crusher fines.

In some embodiments, the LRA limestone is refined LRA limestone. The refined LRA limestone is natural LRA limestone and/or LRA limestone crusher fines with at least some light fraction hydrocarbons removed or extracted therefrom.

An exemplary embodiment can relate to Portland cement mix. The Portland cement mix can include clinker material, the clinker material having been produced from various materials including Limestone Rock Aggregate (“LRA”) limestone.

In some embodiments, the LRA limestone is natural LRA limestone and/or LRA limestone crusher fines.

In some embodiments, the LRA limestone is refined LRA limestone. The refined LRA limestone is natural LRA limestone and/or LRA limestone crusher fines with at least some light fraction hydrocarbons removed or extracted therefrom.

An exemplary embodiment can relate to a method of fabricating clinker material for Portland cement or a mineralogical equivalent thereof. The method can involve manipulating the gradation, or prevalence of various particle sizes, of a volume of limestone material containing Limestone Rock Aggregate (“LRA”) limestone through ordinary means including, but not limited to, crushing, grinding, screening, and/or washing to use as a component of clinker precursor; and kiln treating the clinker precursor to form clinker.

In some embodiments, the limestone material: consist of LRA limestone; consists essentially of LRA limestone; or comprises LRA limestone.

In some embodiments, the limestone material: includes a mixture of pure or common limestone and LRA limestone.

In some embodiments, the limestone material comprises: a) natural LRA limestone; or b) a mixture of pure or common limestone and natural LRA limestone, and the limestone material is crushed such that the limestone material has an average diameter of three inches or less; or the limestone material consists of LRA limestone crusher fines, and no crushing is performed on the LRA limestone crusher fines to produce the clinker precursor.

In some embodiments, the method involves treating the LRA limestone to generate refined LRA limestone by removing or extracting at least some light fraction hydrocarbons.

In some embodiments, light fraction hydrocarbons include hydrocarbon fractions having molecular weights from C1 to C14.

An exemplary embodiment can relate to a method of fabricating Portland cement. The method can involve mixing an embodiment of clinker with limestone and gypsum.

In some embodiments, kiln treating the clinker precursor burns hydrocarbon fractions contained by the LRA limestone.

In some embodiments, kiln treatment involves applying heat to the clinker precursor to raise the temperature of the clinker precursor within a range from 932° F. to 2,000° F.

In some embodiments, kiln treatment causes calcium carbonate to react with silica to form calcium silicates. The minimum temperature at which calcium carbonate reacts with silica to form calcium silicates is 932° F.

An exemplary embodiment can relate to a method of improving strength of Portland cement or a mineralogical equivalent thereof. The method can involve adding Limestone Rock Aggregate (“LRA”) limestone as a component to manufacture clinker for the Portland cement or the mineralogical equivalent thereof; and/or adding LRA limestone to a Portland cement mix or a mineralogical equivalent mix thereof. The LRA limestone imparts carbon nanostructures to the Portland cement or the mineralogical equivalent thereof.

In some embodiments, the carbon nanostructures include graphene flakes.

### BRIEF DESCRIPTION OF THE DRAWINGS

The above and other objects, aspects, features, advantages, and possible applications of embodiments of the present innovation will be more apparent from the following more particular description thereof, presented in conjunction with the following drawings. Like reference numbers used in the drawings may identify like components.

FIG. 1 is an exemplary process flow diagram for manufacturing Portland cement.

FIG. 2 is an exemplary illustration of an embodiment of an extraction process (using heat, chemical, and/or mechanical energy) that can be used to extract light hydrocarbons from LRA limestone.

FIG. 3 is an exemplary gradation process that can be used to further refine LRA limestone.

### DETAILED DESCRIPTION

The following description is of exemplary embodiments and methods of use that are presently contemplated for carrying out the present invention. This description is not to be taken in a limiting sense, but is made merely for the purpose of describing the general principles and features of various aspects of the present invention. The scope of the present invention is not limited by this description.

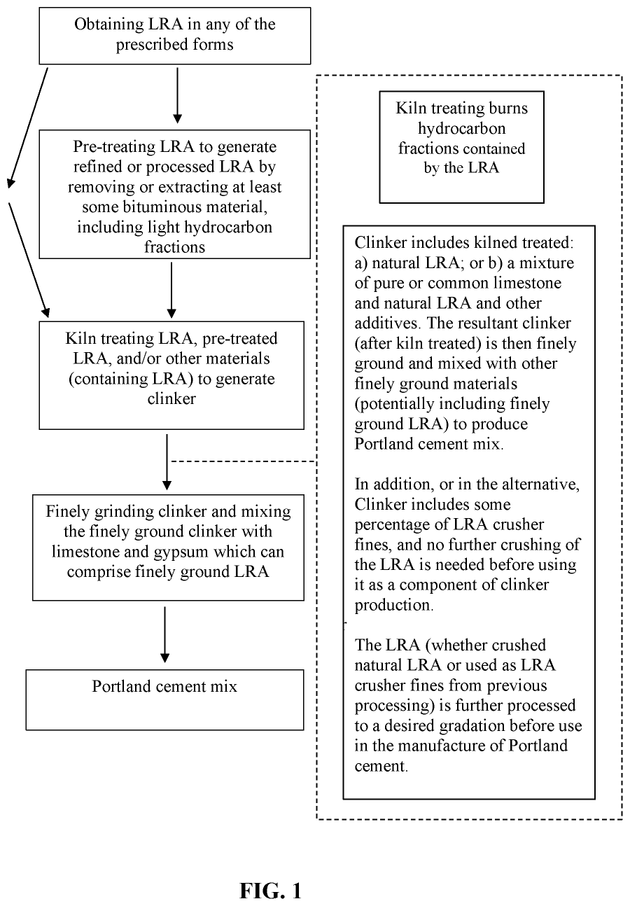

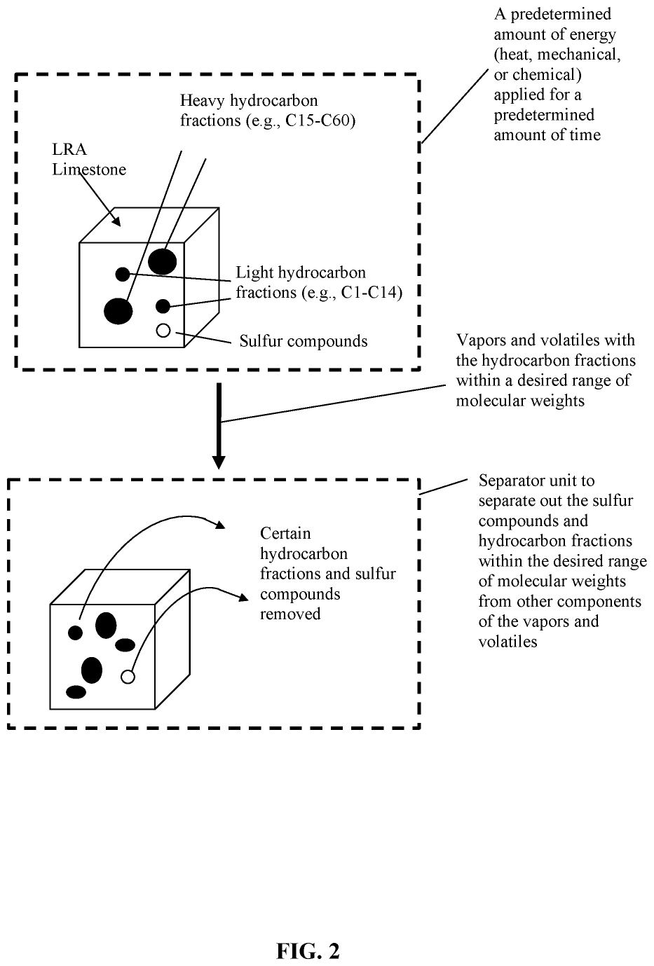

Referring to FIGS. 1 and 2, embodiments relate to use of LRA limestone as a component of clinker, wherein the clinker is used to manufacture Portland cement mineralogical equivalents or mineralogical equivalents thereof. LRA limestone is a naturally occurring limestone deposit that has been impregnated with various bituminous components, including asphaltenes and lighter hydrocarbons. These hydrocarbon components provide an added British Thermal Unit (“BTU”) value to the LRA limestone as compared to pure or common limestone—e.g., the hydrocarbon components serve as fuel when kiln treated. Thus, manufacturing clinker, and therefore manufacturing Portland cement, can require less energy if LRA is used as a component of clinker.

Methods of manufacturing Portland cement involve combining crushed limestone (e.g., pure or common limestone that has been crushed) with other material and fluxes (e.g., alite, belite, tricalcium aluminate, tetracalcium alumino ferrite, etc.), and then kiln heating them to generate clinker. Embodiments of the innovative method disclosed herein can involve use of LRA limestone instead of crushed limestone or use of LRA limestone in combination with the crushed common or pure limestone. Generally, the more LRA limestone used as opposed to pure or common limestone, the more benefit can be availed from the LRA limestone. The proportion of LRA limestone to pure or common limestone, that is, the percentage of LRA limestone used overall when making the clinker precursor that will be kiln treated to form clinker or further processed into Portland cement, can be manipulated by changing the gradation of the LRA limestone used, as there may be other factors that warrant the use of a desired amount of pure or common limestone or LRA limestone—e.g., processing optimization, energy efficiency, material costs, desired material properties, etc. Thus, while embodiments discuss replacing pure or common limestone with LRA limestone, it is understood that the clinker precursor material can comprise any ratio of LRA limestone to pure or common limestone: a 1:1 ratio, a 1:2 ratio; a 1:10 ratio, a 1:100 ratio, a 2:1 ratio, a 10:1 ratio, a 100:1 ratio, etc. In some cases, it may be desirable to use no pure or common limestone at all.

After the desired LRA limestone content is determined for the clinker precursor, the clinker precursor is then kiln treated to produce clinker. Clinker is a precursor to Portland cement. The kiln treatment can involve a pyroprocess intended to bring about a desired chemical or physical reaction, and in this case the desired chemical reaction may include calcium carbonate reacting with silica to form calcium silicates. As noted herein, the LRA limestone has a naturally occurring BTU value, so the more LRA limestone used, the more fuel available in the clinker precursor that is converted to heat when kiln treating the clinker precursor to generate clinker, thereby making the kiln treatment more efficient as compared to the use of pure or common limestone as the clinker precursor. Also of note is that the natural process that impregnated or “infused” the bituminous material into LRA limestone also degraded the LRA limestone rock. This degradation also produces the net result of making the LRA limestone easier to heat to a point of degradation versus pure or common limestone, which saves energy when kiln heating LRA limestone versus pure or common limestone.

The clinker can then be ground into a fine powder, and mixed with finely ground limestone and gypsum (and potentially other materials) to generate a mixture of Portland cement. Finely ground LRA limestone can be used for this purpose as well, potentially resulting in a stronger Portland cement. The resultant mixture (the Portland cement mix) can be ground again to ensure uniformity of particle size.

The LRA limestone (LRA limestone or LRA crusher fines) can be treated before being used as a component of the clinker precursor. The treatment of the LRA limestone can involve removal, or extraction, of certain bituminous material (e.g., light hydrocarbons, sulfur, etc. from the LRA limestone). This extracted bituminous material can be used in other material processes (e.g., those used in the refining of crude oil). The treatment process can be designed to specifically extract (e.g., fully or partially remove) light hydrocarbon fractions (e.g., fractions with a molecular weight of less than C14) from the LRA limestone. Hydrocarbons (crude oil) often naturally contain high amounts of sulfur (often called “sour crude”). Sulfur is not a desirable component of limestone used to manufacture Portland cement. Sulfur is present in LRA limestone, but the liquid hydrocarbon extraction process is shown to remove the sulfur along with related hydrocarbons using the same process. Indeed, the liquid hydrocarbon extract from LRA limestone is often marketed to refineries as “sour crude”.

The extraction process can involve freeing or loosening hydrocarbon fractions from the matrix of the LRA limestone. The known technique for freeing or loosening the hydrocarbon fractions from the matrix of the LRA limestone is briefly summarized by adding energy to small LRA limestone particles, which allows for the removal of the hydrocarbon fractions. The more energy that is applied, the more and/or heavier the removed hydrocarbons become. The energy applied to the LRA limestone for hydrocarbon extraction can be heat energy, mechanical energy, chemical energy (e.g., use of a hydrocarbon rich solvent), or some combination of all three. Embodiments of the hydrocarbon extraction process can be appreciated from U.S. Pat. No. 10,961,462 and U.S. 63/489,031, the entire contents of each being incorporated herein by reference.

The energy imparted to the LRA limestone frees or loosens the hydrocarbon fractions from the matrix of the LRA limestone. Adjustments to the energy applied and other processing steps can be done to control which hydrocarbon fractions and how much of the hydrocarbon fractions can be freed or loosened from the LRA limestone matrix. For instance, hydrocarbon fractions having molecular weights from C1 to C60 (or any range there-between) can be freed or loosened. Hydrocarbon fractions having molecular weights from C1 to C14 can be referred to as light hydrocarbon fractions. As noted herein, it is desirous to extract the light hydrocarbon fractions from the LRA limestone. Thus, energy can be imparted to free or loosen the light hydrocarbon fractions (and in some cases sulfur compounds as well) from the LRA limestone, wherein further processing can be done to remove or extract these light hydrocarbon fractions (and in some cases sulfur compounds as well) from the LRA limestone. The light hydrocarbon fractions and/or sulfur compounds can be used in other processes (e.g., refining of crude oil), whereas the treated LRA limestone can be used in the manufacture of clinker or Portland cement.

One of the ways to impart energy on the LRA limestone is to apply heat. Another way is via a chemical process. These two methods are described in detail in U.S. Pat. No. 10,961,462. Another way is via mechanical processes (e.g., mechanical agitation, application or pressure, etc.). This method is described in U.S. 63/489,031. Embodiments can involve the use of any one or combination of heat, mechanical, or chemical means to loosen or free the hydrocarbon fractions from the matrix.

An exemplary means to impart energy to free or loosening the hydrocarbon fractions form the matrix via chemical processes is through the use of a solvent, wherein the solvent, which when applied, can form a hydrocarbon rich solvent solution that is free from the matrix of the LRA limestone. In addition, or in the alternative, the LRA limestone and/or the hydrocarbon rich solvent solution can be subjected to a heating treatment to free or loosen hydrocarbon fractions from the matrix of the LRA limestone. In addition, or in the alternative, the LRA limestone can be subjected to mechanical energy to free or loosen hydrocarbon fractions from the matric of the LRA limestone. When used in combination, the chemical/heating/mechanical treatment(s) can be used before, during, and/or after the other form of treatment.

The LRA limestone and/or the hydrocarbon rich solvent solution can then be subjected to a separator to separate and withdraw the desired hydrocarbon fractions of certain molecular weights from the LRA limestone and/or solution, thereby forming the resultant extraction material. This can involve use of condensation columns, centrifuges, separators, etc. Other mechanical, electrical, and/or chemical systems, in addition to or in lieu of the separator, can be used to facilitate withdrawal of the hydrocarbon fractions from the LRA limestone and/or the hydrocarbon rich solvent solution.

Hydrocarbon fractions having molecular weights from C1 to C14 can be referred to herein as light hydrocarbon fractions. Hydrocarbon fractions having molecular weights greater than C14 can be referred to herein as heavy hydrocarbon fractions. While the extraction process can be used to extract hydrocarbon fractions from the LRA limestone having molecular weights from C1 to C14 (or any other range there-between), the extraction process can be used to extract hydrocarbon fractions from the LRA limestone having molecular weights from C1 to C60 (or any range there-between). It is contemplated to utilize the method to more aggressively extract the light-weight hydrocarbons (e.g., C1 to C14) because doing so would be most beneficial for reasons explained herein (e.g., removal of light hydrocarbon fractions is optimal in conditioning the LRA limestone for use as a component of clinker and/or Portland cement, and such removal can reduce or prevent safety or environmental hazards). Other factors may be used that would cause one to utilize the method to more aggressively extract other molecular weight ranges of hydrocarbons.

For instance, with embodiments that are designed to more aggressively extract hydrocarbon fractions from the LRA limestone having molecular weights from C1 to C14, the extraction process can be configured to generate a resultant extraction material having hydrocarbon fractions with molecular weights comprising any one or combination of: C1; C1 and/or C2; C1, C2, and/or C3; C1, C2, C3, and/or C4; C1, C2, C3, C4, and/or C5; C1, C2, C3, C4, C5 and/or C6; C1, C2, C3, C4, C5, C6, and/or C7; C1, C2, C3, C4, C5, C6, C7, and/or C8; C1, C2, C3, C4, C5, C6, C7, C8, and/or C9; C1, C2, C3, C4, C5, C6, C7, C8, C9, and/or C10; C1, C2, C3, C4, C5, C6, C7, C8, C9, C10, and/or C11; C1, C2, C3, C4, C5, C6, C7, C8, C9, C10, C11, and/or C12; C1, C2, C3, C4, C5, C6, C7, C8, C9, C10, C11, C12, and/or C13; and/or C1, C2, C3, C4, C5, C6, C7, C8, C9, C10, C11, C12, C13, and/or C14. As another example, with embodiments that are designed to more aggressively extract hydrocarbon fractions from the LRA limestone having molecular weights from C5 to C10, the extraction process can be configured to generate a resultant extraction material having hydrocarbon fractions with molecular weights comprising any one or combination of: C5; C5 and/or C6; C5, C6, and/or C7; C5, C6, C7, and/or C8; C5, C6, C7, C8, and/or C9; C5, C6, C7, C8, C9 and/or C10. As another example, with embodiments that are designed to more aggressively extract hydrocarbon fractions from the LRA limestone having molecular weights from C25 to C30, the extraction process can be configured to generate a resultant extraction material having hydrocarbon fractions with molecular weights comprising any one or combination of: C25; C25 and/or C26; C25, C26, and/or C27; C25, C26, C27, and/or C28; C25, C26, C27, C28, and/or C29; C25, C26, C27, C28, C29 and/or C30. Similar molecular weight combinations and permutations can be used for other ranges (other than the exemplary ranges of C1 to C14, C5 to C10, and C25 to C30 described above) of extraction.

The extraction process can involve performing the extraction in iterations. This can involve iteratively extracting hydrocarbon fractions from the LRA limestone in stages. For example, a first treatment (e.g., a first heat, chemical, and/or mechanical treatment) can be used to grossly extract light hydrocarbon fractions (e.g., C1-C14), then a second treatment (e.g., a second heat, chemical, and/or mechanical treatment) can be used to more finely extract additional light hydrocarbon fractions, then a third treatment (e.g., a third heat, chemical, and/or mechanical treatment) can be used to even more finely extract additional light hydrocarbon fractions, etc. As another example, a first treatment can be used to extract a first set of light hydrocarbon fractions (e.g., C1-C3), then a second treatment can be used to extract a second set of light hydrocarbon fractions (e.g., C4-C9), then a third treatment can be used to extract a third set of light hydrocarbon fractions (e.g., C10-C14). This iterative process can be done to prevent or reduce the amount of heavy hydrocarbon fractions from being extracted.

Embodiments of the extraction process can involve subjecting the LRA limestone to the extraction process so that the resultant extraction material comprises any one of: 100% light hydrocarbon fractions to 0% heavy hydrocarbon fractions; 95% light hydrocarbon fractions to 5% heavy hydrocarbon fractions; 90% light hydrocarbon fractions to 10% heavy hydrocarbon fractions; 85% light hydrocarbon fractions to 15% heavy hydrocarbon fractions; 80% light hydrocarbon fractions to 20% heavy hydrocarbon fractions; 75% light hydrocarbon fractions to 25% heavy hydrocarbon fractions; 70% light hydrocarbon fractions to 30% heavy hydrocarbon fractions; 65% light hydrocarbon fractions to 35% heavy hydrocarbon fractions; 60% light hydrocarbon fractions to 40% heavy hydrocarbon fractions; 65% light hydrocarbon fractions to 45% heavy hydrocarbon fractions; 50% light hydrocarbon fractions to 50% heavy hydrocarbon fractions; 45% light hydrocarbon fractions to 55% heavy hydrocarbon fractions; 40% light hydrocarbon fractions to 60% heavy hydrocarbon fractions; 35% light hydrocarbon fractions to 65% heavy hydrocarbon fractions; 30% light hydrocarbon fractions to 70% heavy hydrocarbon fractions; 25% light hydrocarbon fractions to 75% heavy hydrocarbon fractions; 20% light hydrocarbon fractions to 80% heavy hydrocarbon fractions; 15% light hydrocarbon fractions to 85% heavy hydrocarbon fractions; 10% light hydrocarbon fractions to 90% heavy hydrocarbon fractions; 5% light hydrocarbon fractions to 95% heavy hydrocarbon fractions; 0% light hydrocarbon fractions to 100% heavy hydrocarbon fractions; or any range within the ranges identified above.

For instance, assume the LRA limestone has hydrocarbon fractions with molecular weights from C1 to C60, and a user wants to utilize the method to more aggressively extract hydrocarbon fractions from the LRA limestone so that the resultant extracted material consists of or consists essentially of hydrocarbon fraction with molecular weights from C1 to C14, thereby leaving the C15 to C60 hydrocarbon fractions behind (leave them in the LRA limestone). The extraction process can be configured to generate a resultant extraction material having hydrocarbon fractions with molecular weights comprising any one or combination of: C1; C1 and/or C2; C1, C2, and/or C3; C1, C2, C3, and/or C4; C1, C2, C3, C4, and/or C5; C1, C2, C3, C4, C5 and/or C6; C1, C2, C3, C4, C5, C6, and/or C7; C1, C2, C3, C4, C5, C6, C7, and/or C8; C1, C2, C3, C4, C5, C6, C7, C8, and/or C9; C1, C2, C3, C4, C5, C6, C7, C8, C9, and/or C10; C1, C2, C3, C4, C5, C6, C7, C8, C9, C10, and/or C11; C1, C2, C3, C4, C5, C6, C7, C8, C9, C10, C11, and/or C12; C1, C2, C3, C4, C5, C6, C7, C8, C9, C10, C11, C12, and/or C13; and/or C1, C2, C3, C4, C5, C6, C7, C8, C9, C10, C11, C12, C13, and/or C14.

As another example, assume the LRA limestone has hydrocarbon fractions with molecular weights from C1 to C40, and a user wants to utilize the method to more aggressively extract hydrocarbon fractions from the LRA limestone so that the resultant extracted material consists of or consists essentially of hydrocarbon fraction with molecular weights from C5 to C10, thereby leaving the C1 to C4 and C11 to C40 hydrocarbon fractions behind (leave them in the LRA limestone). The extraction process can be configured to generate a resultant extraction material having hydrocarbon fractions with molecular weights comprising any one or combination of: C5; C5 and/or C6; C5, C6, and/or C7; C5, C6, C7, and/or C8; C5, C6, C7, C8, and/or C9; C5, C6, C7, C8, C9 and/or C10.

As another example, assume the LRA limestone has hydrocarbon fractions with molecular weights from C10 to C50, and a user wants to utilize the method to more aggressively extract hydrocarbon fractions from the LRA limestone so that the resultant extracted material consists of or consists essentially of hydrocarbon fraction with molecular weights from C25 to C30, thereby leaving the C10 to C24 and C31 to C50 hydrocarbon fractions behind (leave them in the LRA limestone). The extraction process can be configured to generate a resultant extraction material having hydrocarbon fractions with molecular weights comprising any one or combination of: C25; C25 and/or C26; C25, C26, and/or C27; C25, C26, C27, and/or C28; C25, C26, C27, C28, and/or C29; C25, C26, C27, C28, C29 and/or C30.

An exemplary system that can be used to carry out an embodiment of the extraction process can include a heating vessel, a heat source, and a separator. The heating vessel can be a kiln, ladle, crucible, etc. The heat source can be a furnace (e.g., combustion furnace, electric furnace, induction furnace, etc.), heater, heat pump, etc. The separator can be a condenser, columnar condenser, separator, distiller, etc. Some embodiments can further include fluid displacement mechanism to force or assist the movement of the LRA limestone, hydrocarbon rich solvent solution, or resultant extraction material throughout the system. This can include a pump, a paddle, a propeller, etc.

For instance, the system can include a heating vessel configured to contain LRA limestone and/or solvent that will be heated. The heating vessel can be connected to, positioned proximate to, or placed within the heating source. The heating vessel can be connected to the separator so that vapors and volatiles driven off by the heating process are directed from the heating vessel to the separator. The vapors and volatiles contain the hydrocarbon fractions within the desired range of molecular weights to be extracted (e.g., the C1 to C14, the C5 to C15, etc.). Adjustment of the heating treatment and/or the solvent used can be done to adjust the molecular weights of hydrocarbon fractions that will be in the vapors and volatiles. The separator can be configured to separate out the desired hydrocarbon fractions from other components. At least one fluid displacement mechanism can be connected to a portion of the system to force or assist the movement of LRA limestone, hydrocarbon rich solvent solution, and/or resultant extraction material.

In a non-limiting, exemplary operation of the system, LRA limestone can be placed inside the heating vessel. The heating vessel can be placed on, at, near, or within the heating source so that heat is transferred to the LRA limestone. The heating vessel and/or separator can be configured to prevent any vapors and volatiles being driven off from the LRA limestone to flow from the heating vessel until permitted to do so. This can be achieved via the use of valves, for example. Thus, the system can operate under heating campaigns. A heating campaign can be subjecting the LRA limestone (and solvent if a solvent is used) to a heating treatment. The heating treatment can include subjecting the LRA limestone and/or solvent to a predetermined amount of heat (a predetermined temperature or a predetermined range of temperatures) for a predetermined time duration.

Increasing any one or combination of the temperature and the time duration can increase the amount of hydrocarbon fractions that become free. In addition, increasing any one or combination of the temperature and the time duration can increase the proportional amount of light hydrocarbon fractions that become free. Naturally, increasing these operating parameters can increase the costs associated with operating the system, and thus a cost-benefit analysis can be performed. Thus, the heating campaign can be adjusted to adjust the amount and/or molecular weight of hydrocarbon fraction material to be extracted. For instance, the greater the temperature, and the time duration used for the heating campaign, the greater the amount and the greater the molecular weight of hydrocarbon fraction material is driven off as vapor or volatiles. As can be appreciated, one can perform a cost-benefit analysis to determine the optimal heating campaign that would result in a maximum amount of desired molecular weight hydrocarbon fraction material at the minimal cost.

The vapor or volatiles generated during the heating treatment can be directed to the separator. As noted herein, some embodiments use a solvent to generate a solvent solution for, and thus the vapor or volatiles can include a hydrocarbon rich solvent solution. An embodiment of the separator can be configured as a condenser having a tube (inner tube) within a tube (outer tube). The vapor or volatiles can be directed through the inner tube, while coolant (e.g., H₂O) is circulated throughout the outer tube. The coolant can cause the vapor or volatiles to cool and condense, which can condense to a liquid. This liquid can contain the resultant extracted material. The types of hydrocarbon fractions (e.g., light, heavy, etc.) and the relative amounts of hydrocarbon fractions within the resultant extracted material will be a function of the LRA limestone used, the solvent used, and the operating parameters of the heating treatment.

It should be noted that embodiments of the system and method can be operated without any application of pressure (positive or negative) in the system. While embodiments of the system may be configured to utility pressure, no pressure or vacuum is necessary for effective use of the system. For instance, the vapor and volatiles are driven up through the separator and cool and condense before reaching any vent or opening in the separator. The condensed vapors and volatiles are then collected. Thus, no pressure is necessary for proper and effective operation of the system. In addition, because no vapor or volatiles reach the vent, none of the hydrocarbon fractions have to be vented off (or otherwise escape the system) or flared off.

As a non-limiting example, the system can be operated at 350° F. for 30 minutes to generate a resultant extracted material having a 25% hydrocarbon extraction yield by weight of hydrocarbon fractions (i.e., if 100 grams of LRA limestone is put in the heating vessel, 25 grams of hydrocarbon fractions can be extracted). Thus, the hydrocarbon extraction yield at these operating parameters can be 25%. Test results on this resultant extracted material reveal that 70% of these 25 grams of hydrocarbon fractions are within the range of C1 to C20, and 30% of these 25 grams of hydrocarbon fractions are greater than C20. This type of yield can be referred to as light hydrocarbon fraction extraction yield. Even though light hydrocarbon fractions are defined herein as being within the range from C1 to C14, increasing the percentage of C1 to C20 hydrocarbons in the extracted material will increase the amount of C1 to C14 hydrocarbons, thereby increase the light hydrocarbon extraction yield. As noted above, the heating campaign can be adjusted to adjust the amount and/or molecular weight of the hydrocarbon fractions within the resultant extracted material. Thus, operating temperatures greater than 350° F. and at time durations greater than 30 minutes can result in greater than 25% hydrocarbon extraction yield and/or greater than 70% light hydrocarbon fraction extraction yield.

Another exemplary system that can be used to carry out an embodiment of the extraction process can include a particle collider. The particle collider can receive LRA limestone, wherein one or more high pressure pumps can force streams of LRA limestone into each other. This collision is an example of imparting mechanical energy into the LRA limestone.

Another technique that can be used to adjust the hydrocarbon extraction yield and/or the light hydrocarbon fraction extraction yield can be adjusting the mix used as the LRA limestone. Some LRA limestone material can be dryer than others. A mixture comprising a combination of a less dry LRA limestone and a more dry LRA limestone can be used to further adjust the hydrocarbon extraction yield and/or the light hydrocarbon fraction extraction yield. For instance, a greater hydrocarbon extraction yield and/or light hydrocarbon fraction extraction yield can be obtained from LRA limestone that comprises a mixture of wet and dry LRA limestone, as opposed to a mixture consisting of wet LRA limestone only or consisting of dry LRA limestone only. Without wishing to being limited by theory, it is hypothesized that the mixture provides improved yields because the lighter hydrocarbon fractions in the less dry LRA limestone serve to loosen the hydrocarbon fractions in the more dry LRA limestone, thereby acting as a solvent for the mixture.

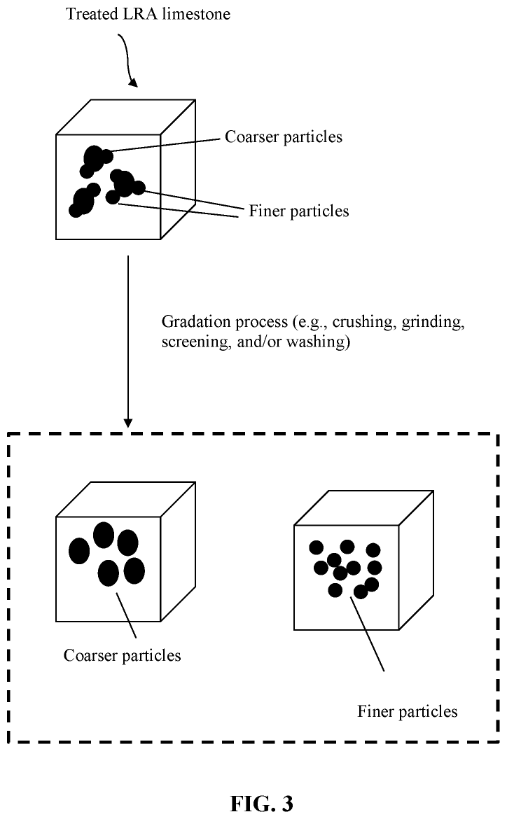

Referring to FIG. 3, during and/or after treating using heat, chemical, and/or mechanical means to free or loosen the hydrocarbon fractions, an additional step can be performed to further enhance the treated LRA limestone. This step can be referred to a gradation process. The gradation process can be part of the heat, chemical, and/or mechanical treatment or be an additional step. Thus, the “treated” LRA limestone can refer to LRA limestone that has been treated via the heat, chemical, and/or mechanical treatment or the LRA limestone that has gone through the gradation process in addition to the heat, chemical, and/or mechanical treatment. The gradation process involves crushing, grinding, screening, and/or washing the treated LRA limestone. Doing this can further break away the free or loosened hydrocarbon fractions from the treated LRA limestone. Specifically, the gradation process separates finer particles from coarser particles, wherein screening can be used to filter out the coarser particles. Generally, the coarser particles are the LRA limestone material that is desired—i.e., the coarser particles of the treated LRA limestone material have more light hydrocarbon fractions and sulfur removed therefrom than do the finer particles of the treated LRA limestone. While washing and screening can achieve the bulk of this gradation, other processes such as crushing and grinding can assist in this regard. Washing can be done with water or other surfactants. Discussed below are three examples that demonstrate the effects of the gradation process. In the first example, little to no washing and screening was performed on the LRA limestone. In the second example, extensive washing and screening was performed on the LRA limestone. In the third example, a moderate amount of washing and screen was performed on the LRA limestone. As can be appreciated from the results, the more washing and screening that was performed, the greater the amount of LRA limestone was generated having little to no light hydrocarbon fraction and sulfur compounds.

Regardless of pre-treating the LRA limestone, the LRA limestone can provide significant advantages as compared to pure or common limestone. It should be noted, however, that processing the LRA limestone before use will often, or usually prove necessary when using LRA limestone as a component of Portland cement manufacture. Processing should be thought of as bitumen/hydrocarbon extraction, modifying the gradation of the LRA material, or both. Processing the LRA limestone before use as a component of cement manufacture removes undesirable elements such as sulfur, potentially unsafe elements such as explosive light hydrocarbon fractions, allows the percentage of LRA limestone present in the initial mix of materials to be fired into clinker to be optimized, etc.

In addition, LRA limestone is naturally impregnated with hydrocarbons, and this natural process “degraded” the limestone of the LRA. This degraded nature of the limestone rock of the LRA further reduces the energy required to kiln treat the clinker precursor into clinker. For instance, to cause the desired chemical reaction includes calcium carbonate reacting with silica to form calcium silicates, the heat treatment of the kiln treatment “degrades” the limestone rock so as to facilitate said chemical reaction. Because the limestone rock of LRA is already degraded, less heat is required for this “degradation” to occur.

In addition, it is believed that LRA limestone contains carbon nanostructures (e.g., graphene flakes). It has long been known to science that adding carbon nanostructures to various concretes, including Portland cement concrete, improves the strength of the concrete. Thus, the LRA limestone, being used as a component of clinker, can supply these carbon nanostructures. In addition, whether LRA limestone is used as a component of clinker or not, the LRA limestone can be added to a Portland cement mix to supply these carbon nanostructures.

### Examples

As noted herein, LRA limestone is a naturally occurring limestone deposit that has been impregnated with bituminous components, including asphaltenes and lighter hydrocarbon compounds. Because of the presence of the bituminous component, LRA limestone is energy positive, meaning that the naturally occurring bitumen in LRA limestone has an energy value, making it easier to burn than pure or common limestone. The geological process that impregnated the LRA limestone with bituminous material also degraded the rock itself. This degradation also makes LRA limestone easier to burn, even without the presence of energy-positive bitumen.

The presence of energy positive bitumen and degradation of the limestone in LRA result in an energy savings when LRA limestone is to be used as a feedstock for the manufacture of Portland cement. The various residual energy due to presence of bitumen in LRA limestone is illustrated in the below analyses.

### First Report Analysis

This report is chemical analyses of two limestone fines samples. The report characterizes both samples including an oxide analysis and CHN (Carbon, Hydrogen, and Nitrogen) content determination. The report also provides Portland cement raw feed mix designs using the results of the oxide analyses and identifies the caloric values for each material.

Two 5-gallon buckets were used: one bucket was labeled “Raw” and the other labeled “Treated”.

The results of the chemical analyses are presented in Table 1.

TABLE 1
Oxide Composition, Moisture Content, and Acid
Insoluble Residue of Raw and Treated Samples

| | Raw | Treated |
|---|---|---|
| Silicon Dioxide, SiO₂ | 3.38% | 3.04% |
| Aluminum Oxide, Al₂O₃ | 0.91% | 0.74% |
| Iron Oxide, Fe₂O₃ | 1.75% | 1.75% |
| Calcium Oxide, CaO | 45.74% | 47.13% |
| Magnesium Oxide, MgO | 0.64% | 0.64% |
| Sodium Oxide, Na₂O | 0.02% | 0.01% |
| Potassium Oxide, K₂O | 0.11% | 0.11% |
| Titanium Dioxide, TiO₂ | 0.19% | 0.17% |
| Manganese Dioxide, MnO2 | 0.04% | 0.04% |
| Phosphorus Pentoxide, P2O5 | 0.10% | 0.09% |
| Strontium Oxide, SrO | 0.07% | 0.07% |
| Barium Oxide, BaO | 0.00% | 0.00% |
| Sulfur Trioxide, SO₃ | 2.41% | 2.10% |
| Loss on Ignition (950° C. | 44.65% | 44.12% |
| Total | 100.00% | 100.00% |
| Moisture Content as Received | 1.82% | 8.79% |
| Acid Insoluble Residue | 15.14% | 12.05% |

The results are consistent with a relatively pure limestone. The magnesium oxide values were low, 0.64% in both Raw and Treated. Higher percentages of magnesium oxide can result in unsoundness of the Portland cement. The sodium and potassium oxides were also low, 0.09% and 0.08% expressed and Na₂O equivalent for Raw and Treated, respectively. These low values are helpful when trying to reduce the total alkali content contributed by other raw feed materials.

For the CHN test, the samples were digested in acid to remove the calcium carbonate and any other acid soluble materials leaving the organic components and a small amount of acid insoluble material such as quartz. The acid insoluble residues (“A.I.R.”) were corrected for the presence of quartz (SiO₂) for the calculation of the high caloric value (“HCV”) or gross caloric value and low caloric value (“LVC”) of the samples. The HCV and LCV were calculated using Dulong's equations. The results of the CHN analyses and calculated HCV and LVC values are presented in Table 2.

TABLE 2
Results of the CHN Analyses Conducted
on the Acid Insoluble Residue

| | Raw | Treated |
|---|---|---|
| A.I.R. Corrected for Quartz | 11.76% | 9.01 |
| | CHN Composition on a Whole Sample Basis | |
| Total Carbon | 5.0% | 3.74% |
| Hydrogen | 0.63% | 0.36% |
| Nitrogen | 0.079% | 0.054% |
| Sulfur | 0.60% | 0.006% |
| Oxygen (by Difference) | 5.4% | 4.20% |
| Calculated Values | | |
| HCV | 844.1 kcal/kg | 244.4 kcal/kg |
| LCV | 810.9 kcal/kg | 191.6 kcal/kg |

The oxide values for each sample were used in raw feed design calculations using typical compositions for high-grade limestone, along with alumina, silica, and iron sources. The composition of the assumed values for the high-grade limestone, alumina, silica, and iron sources are presented in Table 3.

TABLE 3
Raw Materials for Raw Feed Design

| | High | Tyche | Tyche LS | | | | |
|---|---|---|---|---|---|---|---|
| Oxides | Rock (LS) | LS Raw | Treated | Clay | Sand | Mill Scale | Iron Ore |
| SiO₂, % | 0.25 | 3.38 | 3.04 | 60.08 | 90.54 | 0.10 | 9.17 |
| Al₂O₃, % | 0.15 | 0.91 | 0.74 | 21.42 | 2.90 | 0.00 | 6.64 |
| Fe₂O₃, % | 0.13 | 1.75 | 1.75 | 6.28 | 2.73 | 99.90 | 69.68 |
| CaO, % | 55.31 | 45.74 | 47.13 | 0.05 | 0.57 | 0.00 | 1.74 |
| MgO, % | 0.40 | 0.64 | 0.64 | 1.86 | 0.10 | 0.00 | 0.60 |
| Na₂O, % | 0.03 | 0.02 | 0.01 | 0.85 | 0.02 | 0.00 | 0.55 |
| K₂O, % | 0.04 | 0.11 | 0.11 | 3.40 | 0.62 | 0.00 | 0.16 |
| TiO₂, % | 0.00 | 0.19 | 0.17 | 0.00 | 0.22 | 0.00 | 0.00 |
| MnO2, % | 0.00 | 0.04 | 0.04 | 0.00 | 0.00 | 0.00 | 0.00 |
| P2O5, % | 0.00 | 0.10 | 0.09 | 0.00 | 0.00 | 0.00 | 0.00 |
| SrO, % | 0.00 | 0.07 | 0.07 | 0.00 | 0.00 | 0.00 | 0.00 |
| BaO, % | 0.00 | 0.00 | 0.00 | 0.00 | 0.05 | 0.00 | 0.00 |
| SO₃, % | 0.02 | 2.41 | 2.10 | 1.00 | 0.04 | 0.00 | 0.04 |
| LOI (950° C.) | 43.66 | 44.65 | 44.12 | 5.10 | 1.74 | 0.00 | 11.40 |
| Total | 99.99 | 100.01 | 100.01 | 100.04 | 99.53 | 100.00 | 99.98 |

The results of calculations presented in Table 4 show that the extracted limestone powder can be used in raw feed mixture proportions.

TABLE 4
Raw Feed Design and Calculated Parameters

| | Raw | Treated |
|---|---|---|
| | High Rock/Tyche | High Rock/Tyche |
| | LS/Clay/ | LS/Clay/ |
| Materials | Sand/Mill Scale | Sand/Iron Ore |
| High Grade Limestone | 57.8% | 53.9% |
| Tyche Limestone | 22.7% | 26.6% |
| Clay | 11.8% | 11.6% |
| Sand | 7.0% | 6.8% |
| Mill Scale | 0.76% | — |
| Iron Ore | — | 0.97% |

| | Calculated Values for Portland | | Typical |
|---|---|---|---|
| Parameters | Cement Clinker | | Ranges |
| Bogue Compounds | | | |
| C3S | 63.00 | 65.00 | 45 to 65 |
| C2S | 16.72 | 14.67 | 10 to 30 |
| C3A | 6.88 | 7.00 | 5 to 15 |
| C4AF | 10.28 | 5.65 | 5 to 12 |
| SO3 | 1.18 | 1.20 | 0 to 1.2 |
| MgO | 0.94 | 0.96 | 0 to 4 |
| NaEq. Alkali | 0.70 | 0.70 | 0.35 to 0.70 |
| | | | (low Alk.) |
| Lime Saturation | 94.05 | 95.00 | 94 to 98 |
| Factor | | | |
| Silica Ratio (SR) | 2.76 | 2.74 | 2 to 3 |
| % Liquid | 23.76 | 23.75 | 20 to 30 |
| Alumina-to- | 1.40 | 1.42 | 1.4 to 1.8 |
| Iron Ratio (AR) | | | |

Parameters such as lime saturation factor (“LSF”), silica ratio (“SR”), Aluminato-iron ratio (AR) percent liquid, and Bogue compound values fall within typical ranges. The calculated values can be refined by using different raw materials.

### Second Report Analysis

This report is chemical analyses of two limestone fines samples. The report characterizes both samples including an oxide analysis and CHN (Carbon, Hydrogen, and Nitrogen) content determination. The report also provides Portland cement raw feed mix designs using the results of the oxide analyses and identify the caloric values for each material.

One 3-gallon bucket was used. The bucket was labeled “LRA Fines”.

The results of the chemical analyses are presented in Table 5.

TABLE 5
Oxide Composition, Moisture Content, and Acid
Insoluble Residue of Raw and Treated Samples

| | LRA Fines |
|---|---|
| Silicon Dioxide, SiO₂ | 3.10% |
| Aluminum Oxide, Al₂O₃ | 0.55% |
| Iron Oxide, Fe₂O₃ | 1.63% |
| Calcium Oxide, CaO | 48.40% |
| Magnesium Oxide, MgO | 0.60% |
| Sodium Oxide, Na₂O | 0.02% |
| Potassium Oxide, K₂O | 0.11% |
| Titanium Dioxide, TiO₂ | 0.09% |
| Manganese Dioxide, MnO2 | 0.04% |
| Phosphorus Pentoxide, P2O5 | 0.08% |
| Strontium Oxide, SrO | 0.07% |
| Barium Oxide, BaO | 0.00% |
| Sulfur Trioxide, SO₃ | 1.10% |
| Loss on Ignition (950° C. | 44.20% |
| Total | 100% |
| Moisture Content as Received | 5.03% |
| Acid Insoluble Residue | 4.39% |

The results are consistent with a relatively pure limestone. The silicon dioxide content was 3.1%. The magnesium oxide value was low, 0.60%. Higher percentages of magnesium oxide can result in unsoundness of the Portland cement. The sodium and potassium oxides were also low, 0.10% expressed and Na₂O equivalent. These low values are helpful when trying to reduce the total alkali content contributed by other raw feed materials.

For the CHN test, the LRA Fines sample was conducted on the whole sample on a dry basis. The acid insoluble residue was conducted to determine the organic and inorganic carbon contents. Calculation of the high caloric value (“HCV”) or gross caloric value and low caloric value (“LVC”) of the sample indicated little to no caloric value. The HCV and LCV were calculated using Dulong's equations. The results of the CHN analyses are presented in Table 6.

TABLE 6
Results of the CHN Analyses Conducted on a Whole Sample Basis

| | LRA Fines |
|---|---|
| A.I.R. Corrected for Quartz | 1.29% |
| | CHN Composition on a |
| | Whole Sample Basis |
| Total Organic Carbon | 3.89% |
| Hydrogen | 0.29% |
| Nitrogen | 0.26% |
| Sulfur | 0.40% |
| Oxygen (by Difference) | 23.1% |

The oxide values for each sample were used in various raw feed design calculations using typical compositions for high-grade limestone, along with alumina, silica, and iron sources. The composition of the assumed values for the high-grade limestone, alumina, silica, and iron sources are presented in Table 7.

TABLE 7
Raw Materials for Raw Feed Design

| | High | Tyche LS | | | | |
|---|---|---|---|---|---|---|
| Oxides | Rock (LS) | LRA Fines | Clay | Sand | Mill Scale | Iron Ore |
| SiO₂, % | 0.25 | 3.10 | 60.08 | 90.54 | 0.10 | 9.17 |
| Al₂O₃, % | 0.15 | 0.55 | 21.42 | 2.90 | 0.00 | 6.64 |
| Fe₂O₃, % | 0.13 | 1.63 | 6.28 | 2.73 | 99.90 | 69.68 |
| CaO, % | 55.31 | 48.40 | 0.05 | 0.57 | 0.00 | 1.74 |
| MgO, % | 0.40 | 0.60 | 1.86 | 0.10 | 0.00 | 0.60 |
| Na₂O, % | 0.03 | 0.02 | 0.85 | 0.02 | 0.00 | 0.55 |
| K₂O, % | 0.04 | 0.11 | 3.40 | 0.62 | 0.00 | 0.16 |
| TiO₂, % | 0.00 | 0.09 | 0.00 | 0.22 | 0.00 | 0.00 |
| MnO2, % | 0.00 | 0.04 | 0.00 | 0.00 | 0.00 | 0.00 |
| P2O5, % | 0.00 | 0.08 | 0.00 | 0.00 | 0.00 | 0.00 |
| SrO, % | 0.00 | 0.07 | 0.00 | 0.00 | 0.00 | 0.00 |
| BaO, % | 0.00 | 0.00 | 0.00 | 0.05 | 0.00 | 0.00 |
| SO₃, % | 0.02 | 1.10 | 1.00 | 0.04 | 0.00 | 0.04 |
| LOI (950° C.) | 43.66 | 44.20 | 5.10 | 1.74 | 0.00 | 11.40 |
| Total | 99.99 | 99.99 | 100.04 | 99.53 | 100.00 | 99.98 |

The results of calculations presented in Table 8 show that the extracted limestone powder can be used in raw feed mixture proportions. The raw mix with the highest replacement of high-grade limestone with the LRA Fines is presented in Table 8. It should be noted, however, that the reason for the increase in the percentage of treated LRA limestone used in Table 8 versus untreated LRA limestone 4 is not primarily due to the hydrocarbon extraction process per se. In Table 4, there is a slight increase in the amount of treated versus untreated LRA limestone that can be used to produce cement. However, the increase is primarily due to the difference in weight of the two LRA limestones caused by the removal of the bituminous load. The primary driver of the amount, or percentage, of LRA limestone that can be used as a component for cement production is the gradation of the LRA limestone. For example, the LRA limestone used in Table 4, which showed and increase to 49.6% LRA limestone from 26.6% of the treated LRA limestone in Table 4, is because the treated material was washed before testing, which removes and/or redistributes various minerology present in the different sizes of LRA limestone particles, resulting in more or less LRA limestone being used in Portland Cement production. Further testing on LRA limestone gradations have shown the same results. Whether using more or less LRA limestone is desirable in the production of Portland Cement is a function of several factors, including the needs of the particular cement producer. Processing LRA limestone for cement production can be manipulated to fit these needs.

TABLE 8
Raw Feed Design and Calculated Parameters

| | High Rock/Tyche LRA Fines/Clay/ |
|---|---|
| Raw Materials | Sand/Mill Scale |
| High Grade Limestone | 32.5% |
| Tyche Limestone | 49.6% |
| Clay | 11.4% |
| Sand | 6.1% |
| Mill Scale | 0.41% |
| Iron Ore | |

| | Calculated Values for | |
|---|---|---|
| Parameters | Portland Cement Clinker | Typical Ranges |
| Bogue Compounds | | |
| C3S | 65 | 45 to 65 |
| C2S | 15 | 10 to 30 |
| C3A | 7 | 5 to 15 |
| C4AF | 10 | 5 to 12 |
| SO3 | 1.06 | 0 to 1.2 |
| MgO | 1.02 | 0 to 4 |
| NaEq. Alkali | 0.70 | 0.35 to 0.70 (low Alk.) |
| Lime Saturation | 95.1 | 94 to 98 |
| Factor | | |
| Silica Ratio (SR) | 2.70 | 2 to 3 |
| % Liquid | 24.1 | 20 to 30 |
| Alumina-to- | 1.37 | 1.4 to 1.8 |
| Iron Ratio (AR) | | |

Parameters such as lime saturation factor (“LSF”), silica ratio (“SR”), Alumina-to-iron ratio (AR) percent liquid, and Bogue compound values fall within typical ranges. The calculated values can be refined by using different raw materials.

### Third Report Analysis

This report is a chemical analysis of one limestone fines sample. The report characterizes the sample including an oxide analysis and BTU determination. The report also provides a Portland cement raw feed mix design using the results of the oxide analyses and identifies the BTU/lb. value for the LRA Feedstock material.

One 5-gallon bucket was used: one bucket was labeled “LRA Feedstock”.

The results of the chemical analyses are presented in Table 9.

TABLE 9
Oxide Composition, Moisture Content, and Acid
Insoluble Residue of the LRA Feedstock Sample

| | LRA Feedstock |
|---|---|
| Silicon Dioxide, SiO₂ | 3.52% |
| Aluminum Oxide, Al₂O₃ | 0.87% |
| Iron Oxide, Fe₂O₃ | 1.69% |
| Calcium Oxide, CaO | 49.23% |
| Magnesium Oxide, MgO | 0.76% |
| Sodium Oxide, Na₂O | 0.01% |
| Potassium Oxide, K₂O | 0.15% |
| Titanium Dioxide, TiO₂ | 0.00% |
| Manganese Dioxide, MnO2 | 0.04% |
| Phosphorus Pentoxide, P2O5 | 0.09% |
| Strontium Oxide, SrO | 0.08% |
| Barium Oxide, BaO | 0.00% |
| Sulfur Trioxide, SO₃ | 1.87% |
| Loss on Ignition (950° C. | 41.68% |
| Total | 100% |
| Moisture Content as Received | 0.13% |
| Acid Insoluble Residue | 5.18% |
| BTU/lb. | 709 |

The results are consistent with a relatively pure limestone. The silicon dioxide content was 3.5%. The magnesium oxide value was low, 0.76%. Higher percentages of magnesium oxide can result in unsoundness of the Portland cement. The sodium and potassium oxides were also low, 0.11% expressed and Na₂O equivalent. These low values are helpful when trying to reduce the total alkali content contributed by other raw feed materials.

The oxide values for each sample were used in various raw feed design calculations using typical compositions for high-grade limestone, along with alumina, silica, and iron sources. The composition of the assumed values for the high-grade limestone, alumina, silica, and iron sources are presented in Table 10.

TABLE 10
Raw Materials for Raw Feed Design

| | | Tyche | | | | |
|---|---|---|---|---|---|---|
| | High | LS LRA | | | | |
| Oxides | Rock (LS) | Feedstock | Clay | Sand | Mill Scale | Iron Ore |
| SiO₂, % | 0.25 | 3.52 | 60.08 | 90.54 | 0.10 | 9.17 |
| Al₂O₃, % | 0.15 | 0.87 | 21.42 | 2.90 | 0.00 | 6.64 |
| Fe₂O₃, % | 0.13 | 1.69 | 6.28 | 2.73 | 99.90 | 69.68 |
| CaO, % | 55.31 | 49.23 | 0.05 | 0.57 | 0.00 | 1.74 |
| MgO, % | 0.40 | 0.76 | 1.86 | 0.10 | 0.00 | 0.60 |
| Na₂O, % | 0.03 | 0.01 | 0.85 | 0.02 | 0.00 | 0.55 |
| K₂O, % | 0.04 | 0.15 | 3.40 | 0.62 | 0.00 | 0.16 |
| TiO₂, % | 0.00 | 0.00 | 0.00 | 0.22 | 0.00 | 0.00 |
| MnO2, % | 0.00 | 0.04 | 0.00 | 0.00 | 0.00 | 0.00 |
| P2O5, % | 0.00 | 0.09 | 0.00 | 0.00 | 0.00 | 0.00 |
| SrO, % | 0.00 | 0.08 | 0.00 | 0.00 | 0.00 | 0.00 |
| BaO, % | 0.00 | 0.00 | 0.00 | 0.05 | 0.00 | 0.00 |
| SO₃, % | 0.02 | 1.87 | 1.00 | 0.04 | 0.00 | 0.04 |
| LOI (950° C.) | 43.66 | 41.68 | 5.10 | 1.74 | 0.00 | 11.40 |
| Total | 99.99 | 99.99 | 100.04 | 99.53 | 100.00 | 99.98 |

The results of calculations presented in Table 11 show that the extracted limestone powder can be used in raw feed mixture proportions.

TABLE 11
Raw Feed Design and Calculated Parameters

| | High Rock/Tyche LRA Feedstock/Shale/ | |
|---|---|---|
| Raw Materials | Sand/Iron Ore | |
| High Grade Limestone | 45.8% | |
| Tyche Limestone | 34.2% | |
| Clay | — | |
| Shale | 15.0% | |
| Sand | 4.2% | |
| Mill Scale | — | |
| Iron Ore | 0.8% | |
| | Calculated Values for | |
| Parameters | Portland Cement Clinker | Typical Ranges |
| Bogue Compounds | | |
| C3S | 65 | 45 to 68 |
| C2S | 14 | 10 to 30 |
| C3A | 7 | 5 to 15 |
| C4AF | 10 | 5 to 12 |
| SO3 | 1.20 | 0 to 1.2 |
| MgO | 1.24 | 0 to 4 |
| NaEq. Alkali | 0.75 | 0.38 to 0.70 (low Alk.) |
| Lime Saturation | 95.2 | 94 to 98 |
| Factor | | |
| Silica Ratio (SR) | 2.70 | 2 to 3 |
| % Liquid | 24.2 | 20 to 30 |
| Alumina-to- | 1.40 | 1.4 to 1.8 |
| from Ratio (AR) | | |

The raw mix with the highest replacement of high-grade limestone with the LRA Feedstock is presented in Table 11. Parameters such as lime saturation factor (LSF), silica ratio (SR), Alumina-to-iron ratio (AR) percent liquid, and Bogue compound values fall within typical ranges. The calculated values can be refined by using different raw materials. The BTU value was determined to be 709 BTU/lb.

In its raw state the bitumen in LRA limestone will provide between 14.23% and 14.81% of the energy provided by a similar weight of coal (using the standard calorific value of 5,700 kcal/kg for coal), resulting in an equivalent or near-equivalent reduction in the amount of coal (or any other fuel source) used to fire the limestone. Any reduction in the amount of energy needed to produce Portland Cement is impactful, as cement production consistently ranks among the most polluting human activities. The natural degradation of LRA limestone versus conventional limestone also contributes to an energy savings. The ingredients to make cement (often including common limestone) are fired at a temperature of around 2,700 deg. F. Because of the natural degradation, LRA limestone begins to burn at temperatures below 932 deg. F. Because the level of degradation of LRA limestone is not as consistent as the bitumen load, and because the other components of cement must be fired, the energy savings from LRA limestone degradation are not as clear as from the presence of bitumen. Nonetheless, they are impactful in such an energy-intensive process.

Despite the energy-saving advantages of using LRA limestone as a feedstock for the manufacture of Portland cement, there are drawbacks that can either lower the proportion of LRA limestone to other ingredients used, or even prevent its use altogether. This is because the naturally occurring bituminous elements in LRA limestone can create an unsafe (e.g., explosive) environment during kiln firing, and they do not burn cleanly due to various impurities and pollutants present. However, certain of the bituminous fractions present in the LRA limestone can be removed. Also, treating the LRA limestone by extracting the offending bituminous elements results in a more consistent product for cement production. It should be noted that extracting hydrocarbons from the LRA limestone decreases the energy savings provided by the existing bituminous material (which has been reduced by extracting some of the bituminous material from the LRA limestone). However, the extracted bituminous material still has value to oil refiners and others. The optimized hydrocarbon extraction level, then, is the level which optimizes extracted liquid value from the LRA limestone material versus the value of the energy savings retained by the treated LRA limestone within the context of pollutive/safety considerations of the treated versus untreated LRA limestone, and can be determined through experimentation in production.

Treating the LRA limestone by removing potentially offending bitumen before using it for cement production, while it reduces the caloric value provided by the existing bitumen, does not reduce potential energy savings due to the fact that the LRA limestone has been previously degraded by a natural process versus typical limestone. This natural degradation causes the limestone in LRA to be easier to burn, therefore taking less energy. Common limestone begins to degrade around 1472 deg. F. LRA limestone (from which the natural bitumen has been removed) begins to degrade at a much lower 932 deg. F, a reduction of more than 36%. Some of the energy savings will be lost due to the lower yield of the LRA limestone versus conventional limestone. Crushed LRA limestone weighs about 20% less than an equivalent volume of conventional limestone (correcting for the typical weight of the naturally occurring bitumen). Even if the entire 20% yield is lost from energy savings, the remaining 16% savings is substantial. Optimization of the energy savings can be performed during production.

LRA limestone potentially adds value to Portland cement production not as a feedstock for the kiln fired portion of Portland cement production, but as a final additive as described above. It is known to industry that the addition to concretes of certain carbon nanostructures produces stronger concretes (including concretes using Portland cement as a binder). Mixing finely ground LRA limestone (processed or unprocessed) to the final Portland cement product could have the same net effect as adding these structures separately, resulting in a Portland cement that produces stronger concrete.

As noted herein, the extracted material (e.g., the extracted light hydrocarbons, sulfur compounds, etc.) can be useful in other processes. However, the extracted material can also be further processed to retrieve useful components therefrom—i.e., not only can the extracted material be useful in other processes, itself contains components that can be further extracted therefrom. For instance, the extracted material can have free carbons (e.g., graphene) atoms that may be useful for other purposes. Because the extracted material is extracted from LRA limestone, the LRA limestone itself has these components. Thus, the retrieval processes disclosed below can be applied to the LRA limestone and/or the extracted material to retrieve these components. Details of retrieval process can be appreciated from U.S. 63/606,376, the entire contents of which is incorporated by reference.

Retrieving or recovering the graphene and other components from the LRA limestone and/or extracted material can involve at least two processes. The first process can involve extracting liquid hydrocarbons from the LRA limestone and/or from the extracted material. This can involve using one or more embodiments discussed above. The second process can involve melting the resulting liquid hydrocarbons from the first process. This can involve heating the liquid hydrocarbons in a plasma chamber such that all carbons are removed except for pure graphene. The pure graphene can then be extracted via known methods of graphene extraction. The pure graphene can be used as graphene or used as a graphene precursor.

Preliminary testing indicates that the material relating to graphene in the LRA limestone and/or the extracted material is molecularly unbalanced, which presents the potential for free carbon graphene atoms. The hypothesis is that graphene is present in the LRA limestone and/or the extracted material, and that the graphene formed because when crude oil was trying to form under the limestone deposit that would become the LRA limestone, the LRA limestone failed to hold the pressure. Thus, before all the carbons could molecularly bond, they became trapped in the rock, and it is the rock itself that is preventing some of the carbon from bonding (which carbon wants to do). Depending on the method of retrieval, the most efficient and economical way to retrieve the graphene can be from the natural LRA limestone, the liquid extract, or the spent fines after liquid extraction. Graphene has now been shown by many researchers to add to the strengths (and therefore reduce the required thicknesses) of different concretes, including asphalt concrete and Portland cement concrete (https://www.graphene-info.com/whats-next-graphene-construction-industry-graphenemanchesters-ceo-sheds-light), and thus graphene can be used in enhancing the properties of the Portland cement.

Unusual properties of both the extracted hydrocarbon liquid and LRA limestone itself suggest that they also contain larger than typical amounts of rare earth (and possibly other) elements and compounds. The unusual properties that suggest this are: 1) the liquid extract is not soluble in any known chemical; 2) if the raw LRA limestone (in the form of LRA fines) is tested using a common leach analysis for environmental compliance purposes, then run through the liquid hydrocarbon extraction process, then the spent (processed, e.g., fines from which liquid has been extracted using the previously disclosed processes) fines are re-run through the same analysis, the spent fines still give up the same (or similar) leachate as the raw fines. It is not known what additional elements are present in the LRA limestone that may cause this, but they could include (without limitation):
1. Scandium
2. Yttrium
3. Lanthanum
4. Cerium
5. Praseodymium
6. Neodymium
7. Promethium
8. Samarium
9. Europium
10. Gadolinium
11. Terbium
12. Dysprosium
13. Holmium
14. Erbium
15. Thulium
16. Ytterbium
17. Lutetium
18. Lithium
19. Cobalt
20. Nickel
21. Manganese

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments have been discussed and illustrated herein, it is to be distinctly understood that the invention is not limited thereto but may be otherwise variously embodied and practiced within the scope of the following claims.

What is claimed is:

1. Clinker precursor material, comprising:
Limestone Rock Aggregate (“LRA”) limestone;
wherein the clinker precursor will be kiln treated to form clinker used in the production of Portland Cement or a mineralogical equivalent thereof.

2. Clinker precursor material of claim 1, wherein:
the LRA limestone is natural LRA limestone and/or LRA limestone crusher fines.

3. Clinker precursor material of claim 2, wherein:
the LRA limestone is refined LRA limestone;
the refined LRA limestone is natural LRA limestone and/or LRA limestone crusher fines with at least some light fraction hydrocarbons removed or extracted therefrom.

4. Portland cement mix, comprising:
clinker material, the clinker material having been produced from various materials including Limestone Rock Aggregate (“LRA”) limestone.

5. Portland cement mix of claim 4, wherein:
the LRA limestone is natural LRA limestone and/or LRA limestone crusher fines.

6. Portland cement mix of claim 4, wherein:
the LRA limestone is refined LRA limestone;
the refined LRA limestone is natural LRA limestone and/or LRA limestone crusher fines with at least some light fraction hydrocarbons removed or extracted therefrom.

7. A method of fabricating clinker material for Portland cement or a mineralogical equivalent thereof, the method comprising:
manipulating the gradation, or prevalence of various particle sizes, of a volume of limestone material containing Limestone Rock Aggregate (“LRA”) limestone through ordinary means including, but not limited to, crushing, grinding, screening, and/or washing to use as a component of clinker precursor; and
kiln treating the clinker precursor to form clinker.

8. The method of claim 7, wherein the limestone material:
consist of LRA limestone;
consists essentially of LRA limestone; or
comprises LRA limestone.

9. The method of claim 7, wherein the limestone material:
includes a mixture of pure or common limestone and LRA limestone.

10. The method of claim 7, wherein:
the limestone material comprises: a) natural LRA limestone; or b) a mixture of pure or common limestone and natural LRA limestone, and the limestone material is crushed such that the limestone material has an average diameter of three inches or less; or
the limestone material consists of LRA limestone crusher fines, and no crushing is performed on the LRA limestone crusher fines to produce the clinker precursor.

11. The method of claim 7, comprising:
treating the LRA limestone to generate refined LRA limestone by removing or extracting at least some light fraction hydrocarbons.

12. The method of claim 11, wherein:
light fraction hydrocarbons include hydrocarbon fractions having molecular weights from C1 to C14.

13. A method of fabricating Portland cement, the method comprising:
mixing the clinker of claim 7 with limestone and gypsum.

14. The method of claim 13, wherein:
kiln treating the clinker precursor burns hydrocarbon fractions contained by the LRA limestone.

15. The method of claim 13, wherein:
kiln treatment involves applying heat to the clinker precursor to raise the temperature of the clinker precursor within a range from 932° F. to 2,000° F.

16. The method of claim 13, wherein:
kiln treatment causes calcium carbonate to react with silica to form calcium silicates;
wherein the minimum temperature at which calcium carbonate reacts with silica to form calcium silicates is 932° F.

17. A method of improving strength of Portland cement or a mineralogical equivalent thereof, the method comprising:
adding Limestone Rock Aggregate (“LRA”) limestone as a component to manufacture clinker for the Portland cement or the mineralogical equivalent thereof; and/or
adding LRA limestone to a Portland cement mix or a mineralogical equivalent mix thereof;
wherein the LRA limestone imparts carbon nanostructures to the Portland cement or the mineralogical equivalent thereof.

18. The method of claim 17, wherein:
the carbon nanostructures include graphene flakes.
